(19) United States
(12) Patent Application Publication
(10) Pub. No.: US 2009/0199868 A1
(43) Pub. Date: Aug. 13, 2009

(54) HEATED FOOD PREPARATION SURFACE CLEANING PAD

(75) Inventors: Eric R. Cybulski, Woodbury, MN (US); Arthur V. Lang, Maplewood, MN (US); Jacob J. Orak, Eagan, MN (US); Adriana Paiva, Richmond, TX (US); Lowell C. Zeller, Woodbury, MN (US)

Correspondence Address: 3M INNOVATIVE PROPERTIES COMPANY, PO BOX 33427, ST. PAUL, MN, 55133-3427, US

(73) Assignee: 3M INNOVATIVE PROPERTIES COMPANY, MINNESOTA (US)

(21) Appl. No.: 12/282,076

(22) PCT Filed: Mar. 6, 2007
(86) PCT No.: PCT/US07/05579

§ 371 Date: Feb. 17, 2009

Related U.S. Application Data
(60) Provisional application No. 60/743,456, filed on Mar. 10, 2006.

(51) Int. Cl. A47L 17/08; B08B 1/00; B23P 17/04

(52) U.S. Cl. 134/6; 15/229.11; 29/428

(57) ABSTRACT

A heated surface cleaning pad that can be attached to a bottom portion of a hand tool configured to be used to scrub a heated food preparation surface. According to an embodiment, the cleaning pad is configured to clean a hot griddle surface that has a number of parallel raised ridges. According to another embodiment, the cleaning pad includes a non-woven construction that is impregnated with abrasive particles and/or a liquid cleaner or a dissolvable solid cleaner. In addition, a method of cleaning a hot food preparation surface is provided. According to one embodiment, the method includes the steps of attaching a scrubbing pad to a cleaning tool, contacting the openings in the cleaning surface of the scrubbing pad with the raised ridges of a griddle surface, and scrubbing the griddle surface with the pad until the surface is clean. Moreover, a method of constructing a cleaning pad for cleaning a hot griddle surface is also provided. According to one embodiment, the method includes binding pad elements together such that a cleaning end of the cleaning pad is comprised of end portions of adjacently arranged scrubbing elements.

### CROSS REFERENCE TO RELATED APPLICATION

This application claims the benefit of U.S. Provisional Patent Application No. 60/743,456, filed Mar. 10, 2006, the disclosure of which is incorporated by reference herein in its entirety.

### TECHNICAL FIELD

This invention relates to a method and a device for cleaning griddles using disposable scrubbing pads.

### BACKGROUND OF THE INVENTION

Restaurants commonly have one or more griddle surfaces that provide a flat, hot cooking surface for cooking food items. Often restaurants include both a flat griddle to cook foods such as eggs and pancakes and a grooved griddle to cook meats where a charbroiled appearance is desirable. In addition to the aesthetic appeal associated with food cooked over a grooved griddle, the grooved griddle is preferable over a flat griddle when draining fat out of meat products while cooking the meat is desirable. When cooking meat products on a grooved griddle the meat product rests over raised ridges on the griddle. As the meat product cooks, the fat drains from the meat and collects on the lower surfaces of the griddle that are positioned between the raised ridges on the griddle. Though traditional open flame grills also enable fat to drain from meat products while the meat is cooking, grooved griddles are sometime preferred over traditional open flame grills because they are typically more energy efficient and the temperature of the cooking surface can be more easily controlled.

Cleaning tools have been developed to remove the buildup of grease and food particles on griddles and open flame grills. Exemplary tools are disclosed in U.S. Pat. No. 6,966,094 to Rigakos; U.S. Pat. No. 6,871,377 to Veltrop et al; U.S. Pat. No. 6,443,646 to MacDonald; U.S. Pat. No. 6,351,887 to Hurst; U.S. Pat. No. 6,263,578 to Frantz et al.; U.S. Pat. No. 6,216,306 to Esterson et al.; U.S. Pat. No. 6,039,372 to Noe et al.; U.S. Pat. No. 5,373,600 to Stojanovski et al.; U.S. Pat. No. 5,255,406 to Rood; U.S. Pat. No. 4,668,302 to Kolodziej et al.; U.S. Pat. No. 4,516,870 to Nakozato; U.S. Pat. No. 4,146,943 to Werthermer et al.; U.S. Pat. No. 4,071,983 to Thielen; U.S. Pat. No. 4,056,863 to Gunjian; and U.S. Pat. No. D470,985 to Zemel. Known tools are not particularly well suited for cleaning grooved griddles of various geometric configurations.

Grooved griddles are difficult to clean with tools designed to clean flat griddles or grills. Typically, such tools have problems cleaning the area between the raised portions of the griddle. Known tools for cleaning grooved griddles are less than effective because griddles are not uniform in size or geometric configuration. In addition, known tools often require the user to be positioned too close to the hot griddle surface. Moreover, the useful life and versatility of the entire tool is typically limited by the cleaning element of the tool. Accordingly, there is a need for improved cleaning devices that enable a user to clean a grooved griddle more efficiently and effectively.

### SUMMARY OF THE INVENTION

The invention provides a cleaning element configured to attach to an end of a griddle cleaning tool. The cleaning elements according to the invention are configured to efficiently and effectively clean an uneven grooved griddle surface.

### BRIEF DESCRIPTION OF THE DRAWINGS

FIG. 1 is a perspective assembly view of a griddle cleaning tool including a pad according to an embodiment of the invention positioned over a grooved griddle;

FIG. 2 is an end view of the pad shown in FIG. 1;

FIG. 3a is a perspective view of an alternative embodiment of the pad shown in FIG. 1;

FIG. 3b is a side elevation view of a portion of a grooved griddle surface;

FIG. 3c is side elevation view of a portion of a grooved griddle surface;

FIG. 4a is an end view of the pad shown in FIG. 3a;

FIG. 4b is side elevation view of the pad shown in FIG. 3a on the grooved griddle surface shown in FIG. 3b;

FIG. 4c is side elevation view of the pad shown in FIG. 3a on the grooved griddle surface shown in FIG. 3b;

FIG. 5 is a perspective view of another alternative embodiment of the pad shown in FIG. 1;

FIG. 6 is an end view of the pad shown in FIG. 5;

FIG. 7 is a perspective view of an alternative embodiment of a griddle cleaning tool shown in FIG. 1;

FIG. 8 is a perspective view of an alternative embodiment of a griddle cleaning tool shown in FIG. 1;

FIG. 9 is a perspective assembly view of the pad shown in FIG. 8;

FIG. 10 is a top perspective view of a portion of the griddle cleaning tool in FIG. 8;

FIG. 11 is a bottom perspective view of a portion of the griddle cleaning tool in FIG. 8; and

FIG. 12 is a top perspective view of an alternative embodiment of the portion of the griddle cleaning tool in FIG. 10.

### DETAILED DESCRIPTION

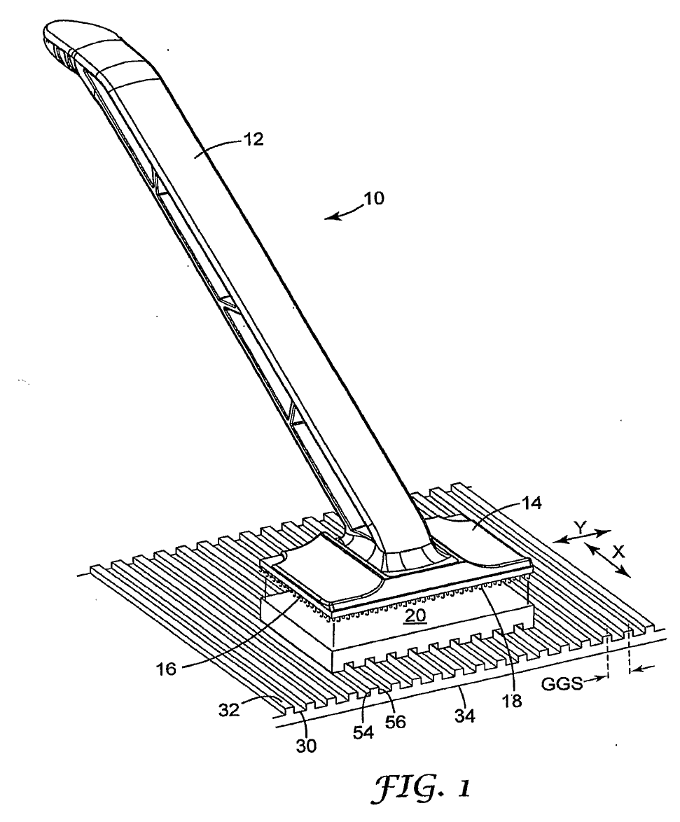

Referring to FIG. 1, a griddle cleaning tool 10 is shown. The tool includes a handle 12 and a foot 14. The bottom surface 16 of the foot 14 includes a plurality of hooks 18, which are configured to engage and secure the pad 20 on the bottom surface 16 of the foot 14. In the embodiment shown the foot 14 and the handle 12 is one piece. In some embodiments the handle and the foot are separate pieces. See Application Ser. No. 60/743,455 docket number 61852US002 having the same filing date as this application in the name of 3M Innovative Properties Company, the subject matter of which is incorporated herein by reference.

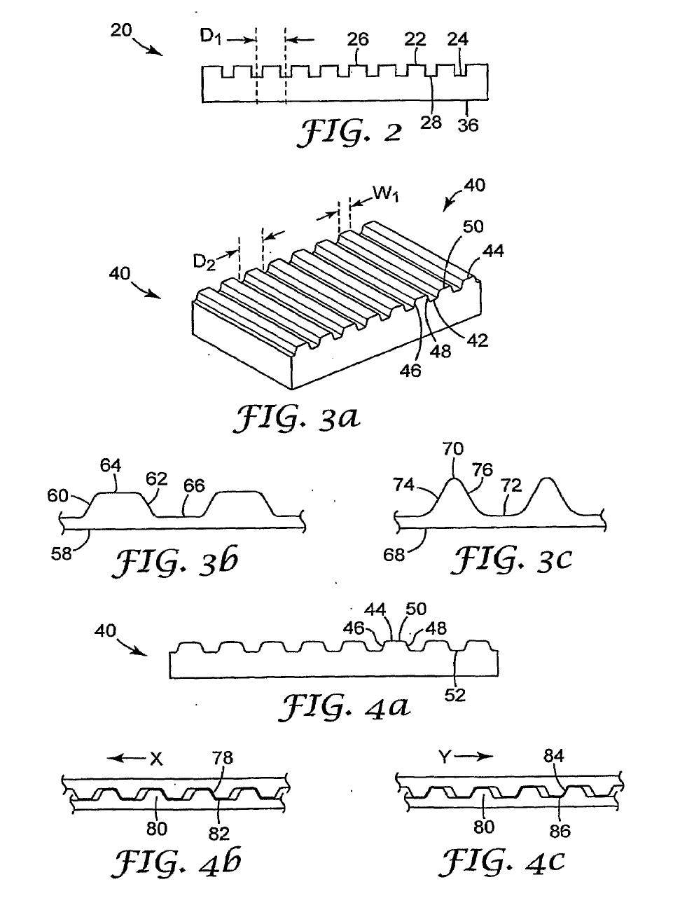

Referring to FIGS. 2 and 3a-c, the pad 20 shown in FIG. 1 is generally rectangular in shape and includes a stepped cross sectional profile. The pad 20 includes peaks 22 separated by valleys 24. The peaks 22 and valleys 24 of pad 20 include flat top surfaces 26 and 28 and are spaced apart by a distance D1. Preferred distance D1 is constant across the pad 20 and matches the griddle groove spacing GGS of whatever griddle model that the pad 20 is designed to clean. Preferably, the spacing D1 is within +/−20% of the groove spacing GGS. Since not all griddles have the same griddle spacing GGS, the pad 20 can be manufactured in several sizes with various peak and valley spacing to accommodate particular differences in griddle spacing. When the pad 20 is in use, the peaks 22 of the pad 20 contacts the low portions 30 (shown in FIG. 1) of the griddle 34 and the valleys 24 of the pad 20 engage the high portions 32 (shown in FIG. 1) of the griddle 34.

Still referring to FIGS. 2 and 3a-c, the top surface (commonly referred to as the back surface) 36 (58 and 68 in FIGS. 3b and 3c respectively) of the pad 20 is configured to be secured to the bottom surface 16 of the foot 14 via the plurality of hooks 18. Once the pad 20 is secured to the foot 14, the griddle can be cleaned by moving the handle 12 back and forth across the griddle 34 until the pad 20 breaks loose the food, grease, and carbonized material from the griddle 34 surface.

It should be understood that the hooks 18 of the foot 14 need not be in the shape shown in the figures, but that the hooks 18 can be in any geometric configuration capable of engaging and securing the pad 20 to the foot 14. In addition, in alternative embodiments the foot 14 may have no hooks 18. Instead, the pad may include an adhesive strip or other engagement mechanisms that secure the pad 20 to the foot or it may include clamps for securing the edge of the pad 20 to the foot 14.

In some embodiments the pad 20 comprises a non-woven substrate suited for scouring heated surfaces. In some embodiments the non-woven substrate also includes solid cleaners disposed therein or thereon that at least partially remove or soften the food soils. In many embodiments, non-woven substrates include non-woven webs of fibers.

In some embodiments the pad 20 can be used in conjunction with a liquid or a solid chemical cleaner. For example, the pad 20 can be used with 3M's commercially available Scotch-Brite Quick Clean Griddle Liquid, which is griddle cleaning liquid intended for use on food contact surfaces and is useful in loosening and lifting carbonized grease and food soil from hot griddle surfaces. In other embodiments, the pad 20 can be impregnated or otherwise attached to a chemical cleaner.

In one embodiment the pad 20 includes features disclosed in PCT Publication Number WO 2007/101866 (3M Innovative Properties Company). The entire PCT filing is incorporated by reference herein and portions of the application are included below.

The following disclosure is believed to be applicable generally to solid cleaners and the use of such solid cleaners on heated surfaces. Specifically, the disclosure is based around a solid cleaner that melts on a heated food preparation surface such as, for example, a grill surface, a griddle surface, or an oven surface. The heated surface can be formed of any material including, for example, metal, ceramic, glass, and/or plastic. These examples, and the examples discussed below, provide an appreciation of the applicability of the disclosed cleaning systems, but should not be interpreted in a limiting sense.

A solid cleaner for heated surfaces is disclosed that includes one or more D solidifying agents and one or more cleaning agents. The solid cleaner is solid at room temperature (e.g., 24 degrees Celsius) and a liquid at an elevated temperature. The elevated temperature can be any useful temperature at which the solid cleaner begins to melt (e.g., melting point.) The solid cleaner can have any useful melting point. In some embodiments, the solid cleaner has a melting point in a range from 35 to 150 degrees Celsius or from 35 to 100 degrees Celsius, or from 45 to 90 degrees Celsius, as desired. Solid cleaners that melt on heated surfaces provide one or more of the following advantages over liquid cleaners: increased dwell time; decreased cleaner evaporation; and/or the ability to be used on vertical heated surfaces. In many embodiments, the solid cleaners have an accelerated cleaning action at elevated temperatures (e.g., above 100 degrees Celsius). In many embodiments, the solid cleaner is generally recognized as safe (GRAS) for food contact.

The solid cleaner can be any defined size or shape. In some embodiments, the solid cleaner has a cube shape, a cuboid shape, a pyramid shape, a cylinder shape, a cone shape, a sphere shape, or portions thereof. In some embodiments, the solid cleaner has a weight from 1 gram to 10 kilograms, or from 1 to 1000 grams, or from 5 to 500 grams, or from 10 to 200 grams. In other embodiments, the solid cleaner is a powder, pellet, flake, tablet, bar, and the like. The solid cleaner can be combined, or used in conjunction with other cleaning articles such as, for example a non-woven scouring pad, as described below, an abrasive coated woven web substrate griddle screen such as, for example SCOTCH-BRITE™ griddle screen number 200, or a pumice block, as desired.

The solid cleaner includes one or more solidifying agents that can assist in forming the solid cleaner. The term “solid” can be defined as a material having a definite volume and configuration independent of its container. Any useful solidifying agent can be used to form the solid cleaner. Any useful amount of solidifying agent can be used to assist in solidifying the solid cleaner. In many embodiments, the solidifying agent is inert or does not assist in the cleaning action of the solid cleaner. In many embodiments, the solidifying agent is generally recognized as safe (GRAS) for food contact. In certain embodiments, the solid cleaner does not need to be rinsed off of the cleaned surface, implying that it is a “no-rinse” cleaner and GRAS for food contact.

In many embodiments, the solidifying agent includes one or more waxes. The wax can be a natural wax or synthetic wax. In some embodiments where the solid cleaner includes wax, the solid cleaner is substantially insoluble in water up to at least 35 degrees Celsius. In some embodiments, the solidifying agent includes a natural wax such as, for example, a beeswax, a candelilla wax, a carnauba wax, a rice bran wax, a lemon peel wax, a soy wax, an orange peel wax, or mixtures thereof. In other embodiments, the solidifying agent includes a synthetic wax such as, for example, Baker-Hugnes (Petrolite) makes Bareco High Melt Microcrystalline waxes (melting point 82 to 93 degrees Celsius), Bareco Flexible Microcrystalline waxes (melting point 65 to 82 degrees Celsius), Starwax™, Victory™, Ultraflex™ and Be Square™ waxes, among others. EMS-Griltech (Switzerland) also makes synthetic low melting polymers such as copolyamide, and copolyesters. Synthetic waxes can also include PEG waxes that are solids such as PEG 1000 NF/FCC, fatty alcohols such as cetyl alcohol, and fatty esters such as propylene glycol monostearate, glycerol monolaurate, and sorbitan esters.

In some embodiments, the solidifying agent includes an emulsifying wax. The emulsifying wax can replace a portion of the one or more waxes, as desired. Emulsifying wax can include, for example, a blend of fatty acids (stearic, palmitic, oleic, capric, caprylic, myristic, and lauric), fatty alcohols (stearyl, cetyl) and/or fatty esters (polysorbates or TWEEN), and the like. In some embodiments, the emulsifying wax is a fatty alcohol such as, for example, stearic alcohol, cetyl alcohol, or mixtures thereof. One example of an emulsifying wax is Emulsifying Wax NF (cas# 67762-27-0; 9005-67-8) and is a blend of cetearyl alcohol, polysorbate 60, PEG-150 stearate & steareth-20. If present, the emulsifying wax to other wax weight ratio can be from 1:1 to 1:5, or from 3:1 to 1:3, or from 2:1 to 1:2 as desired.

Wax can be included in the solid cleaner in any useful amount. In many embodiments, a solidifying amount of wax is included in the solid cleaner. In some embodiments, wax is present in the solid cleaner in a range from 10 to 80 wt %, or from 25 to 75 wt %, or from 30 to 50 wt %.

In some embodiments, the solidifying agent includes a one or more solid polyols. The term “polyol” refers to any organic molecule comprising at least two free hydroxyl groups. Polyols include polyoxyethylene derivatives such as, for example, glycol (diols), triols and monoalcohols, ester, or ethers thereof. Examples of polyols include solids glycols such as, for example, polyethylene glycols (PEG) under the tradename Carbowax series available from Dow Chemical, Midland Mich., polypropylene glycols (PPG) available from Dow Chemical, Midland, Mich., sorbitol and sugars, and solid polyesters such as, for example, poly(ε-caprolactone) under the tradename TONE series from Dow Chemical, Midland Mich., glycerol esters such as, for example, fatty acid mono ester. Fatty acid monoesters include but are not limited to propylene glycol monostearate, glycerol monolaurate, and glycerol monostearate. These esters are GRAS or approved as direct food additives.

Polyol can be included in the solid cleaner in any useful amount. In many embodiments, a solidifying amount of polyol is included in the solid cleaner. In some embodiments, polyol is present in the solid cleaner in a range from 10 to 80 wt %, or from 25 to 75 wt %, or from 30 to 50 wt %.

The solid cleaner includes one or more cleaning agents that can assist in the cleaning action of the solid cleaner. The cleaning agent can be any useful cleaning agent. The cleaning agent can be present in the solid cleaner in any useful amount. In many embodiments, the cleaning agents are generally recognized as safe (GRAS) for food contact.

Cleaning agents include, for example, surfactants, and pH modifiers. In many embodiments, a cleaning amount of cleaning agent is included in the solid cleaner. In many embodiments, the cleaning agent is capable of removing at least a portion of the soil or residue on the heating surface without mechanical scrubbing action. In illustrative embodiments, the cleaning agent is present in the solid cleaner in range from 1 to 90 wt %, or from 1 to 50 wt %, or from 5 to 30 wt %.

In some embodiments, the cleaning agent includes one or more pH modifiers. These pH modifiers include alkaline compounds such as, inorganic alkaline compounds including for example, hydroxides, silicates, phosphates, and carbonates; and organic alkaline compounds including for example, amines. In other embodiments, the pH modifier is an acidic compound such as, for example, citric acid and the like.

In some embodiments, the cleaning agent is a carbonate salt such as, for example, calcium carbonate, potassium carbonate, or sodium carbonate. In some embodiments, the carbonate salt includes potassium carbonate and sodium carbonate that is dissolved in water, forming carbonate ions. In other embodiments, the carbonate salt includes a bicarbonate salt such as, for example, sodium bicarbonate. In further embodiments, the cleaning agent includes a silicate salt such as, for example, sodium metasilicate.

The pH modifiers can be included in the solid cleaner in any useful amount. In many embodiments, the pH modifier is present in the solid cleaner in range from 0.1 to 80 wt %, or from 1 to 50 wt %, or from 5 to 30 wt %. In many embodiments, the solid cleaner has a pH in a range from 7 to 13.

In some embodiments, the cleaning agent includes one or more surfactants. These surfactants include, for example, natural surfactants, anionic surfactants, nonionic surfactants, and amphoteric surfactants. Natural surfactants include, but are not limited to, coconut-based soap solutions. Anionic surfactants include, but are not limited to, dodecyl benzene sulfonic acid and its salts, alkyl ether sulfates and salts thereof, olefin sulfonates, phosphate esters, soaps, sulfosuccinates, and alkylaryl sulfonates. Amphoteric surfactants include, but are not limited to, imidazoline derivatives, betaines, and amine oxides. These surfactants can be included in the solid cleaner in any useful amount. In many embodiments, the surfactant is present in the solid cleaner in range from 5 to 80 wt %, or from 5 to 50 wt %, or from 5 to 30 wt %. In many embodiments, the surfactant is food grade surfactant, approved for use as a direct food additive. Often, food grade surfactants are used so that the cleaning surface does not need to be rinsed.

In some embodiments, the cleaning agent includes carbonate salts such as, for example, sodium and/or potassium carbonate with an amount of surfactant less than 5 wt %, or less than 3 wt %, or less than 1 wt % based on the solid cleaner weight. In some embodiments, the cleaning agent includes carbonate salts such as, for example, sodium and/or potassium carbonate with an amount of a natural surfactant less than 5 wt %, or less than 3 wt %, or less than 1 wt % based on the solid cleaner weight.

The solid cleaner may optionally include one or more carriers. The carrier can be any amount of useful carrier that can provide solubility for any pH modifier and/or provide good food soil pick up and/or have sufficiently low viscosity upon heating and/or allows the solid cleaner to retain its shape at room temperature. In many embodiments, the carrier is generally recognized as safe (GRAS) for food contact. Carriers include, for example, water, glycerin, triethylene glycol, and diethylene glycol. In some embodiments, the carrier is present in the solid cleaner in range from 0 to 80 wt %, or from 1 to 60 wt %, or from 25 to 50 wt %.

In some embodiments, the carrier includes glycerin or glycerol. In certain embodiments, glycerin or glycerol can also act as a solubilizer of soils to be cleaned from the heated surfaces. When present, glycerin can make up from 1 to 80 wt %, or from 1 to 50 wt %, or from 5 to 40 wt %, or from 10 to 30 wt %. In some embodiments, the carrier includes water. When present, water can make up from 1 to 80 wt %, or from 1 to 50 wt %, or from 5 to 40 wt %, or from 10 to 30 wt %. In further embodiments, the carrier includes water and glycerin. When present, water and glycerin can make up from 1 to 80 wt %, or from 1 to 50 wt %, or from 5 to 40 wt %, or from 10 to 30 wt %.

Thickeners can be optionally included in the solid cleaner, as desired. In many embodiments, thickeners can replace a portion of the solidifying agent, as desired. Thickeners can include, for example, xanthan gum, guar gum, polyols, alginic acid, sodium alginate, propylene glycol, methyl cellulose, polymer gels, clay, gelatin/clay mixtures, gelatin/oxide nanocomposite gels, smectite clay, montmorillonite clay, fillers e.g. CaCO₃ and mixtures of therein. If present, thickeners can make up from 0.1 to 25 wt %, or from 0.5 to 10 wt %.

Abrasive material can be optionally included in the solid cleaner, as desired. In many embodiments, the abrasive materials incorporated into the solid cleaning composition can assist in the mechanical scrubbing action and can be used alone or in addition to an abrasive pad described herein. Abrasive materials include, for example, inorganic abrasive particles, organic based particles, sol gel particles or combinations thereof. Further examples of suitable abrasive particles are described in WO 97/49326.

Additives can be optionally included in the solid cleaner, as desired. Additives can include, for example, builders, corrosion inhibitors (e.g., sodium benzoate), sequestering agents (EDTA), dyes, preservatives, and fragrances. In many embodiments, the additives are generally recognized as safe (GRAS) for food contact or approved for use as a direct food additive.

In some embodiments, a non-woven substrate can be combined with the solid cleaners disclosed herein. Non-woven substrates are suited for scouring heated surfaces and can assist in physical removal of food soils at least partially removed or softened by the solid cleaners disclosed herein. In many embodiments, non-woven substrates include non-woven webs of fibers.

In general, non-woven webs of fibers may be made of an air-laid, carded, stitch-bonded, thermobonded and/or resin-bonded construction of fibers, all as known by those skilled in the art. Fibers suitable for use in non-woven substrate materials include natural and synthetic fibers, and mixtures thereof. Synthetic fibers are preferred including those made of polyester (e.g., polyethylene terephthalate), nylon (e.g.; hexamethylene adipamide, polycaprolactam), polypropylene, acrylic (formed from a polymer of acrylonitrile), rayon, cellulose acetate, and so forth. Suitable natural fibers include those of cotton, wool, jute, and hemp. The fiber material can be a homogenous fiber or a composite fiber, such as bicomponent fiber (e.g., a co-spun sheath-core fiber). Non-woven substrate materials may also include different fibers in different portions. In some thermobonded non-woven substrate embodiments, the substrate includes melt bondable fibers where the fibers are bonded to one another by melted portions of the fibers.

In some embodiments, the non-woven substrate material is an open, low density, three-dimensional, non-woven web of fibers, the fibers bonded to one another at points of mutual contact, referred to in the following as a “lofty, nonwoven web material”. In some embodiments, the fibers are thermo-bonded and/or resin-bonded (i.e. with a hardened resin, e.g. a prebond resin) to one another at points of mutual contact. In other embodiments, the fibers are resin-bonded to one another at points of mutual contact. Because the fibers of the web are bonded together at points of mutual contact, e.g. where they intersect and contact one another, a three-dimensional web structure of fibers is formed. The many interstices between adjacent fibers remain substantially unfilled, for example by resin, and thus an open web structure of low density having a network of many relatively large intercommunicated voids is provided. The term “open, low density” non-woven web of fibers is understood to refer to a non-woven web of fibers that exhibits a void volume (i.e. percentage of total volume of voids to total volume occupied by the non-woven web structure) of at least 75%, or at least 80%, or at least 85%, or in the range of from 85% to at least 95%. Such a lofty, non-woven web material is described in U.S. Pat. No. 2,958,593, which is incorporated by reference herein.

Another example of a lofty, non-woven web material is described by U.S. Pat. Nos. 2,958,593, and 4,227,350, which are incorporated by reference herein. These patents disclose a lofty, non-woven web formed from a continuous extrusion of nylon coil material having a diameter in a range from 100 micrometers to 3 mm. Inorganic and/or organic abrasive materials can be optionally included on these non-woven webs.

In some resin-bonded, lofty non-woven web material embodiments, the resin includes a coatable resinous adhesive such as a thermosetting water based phenolic resin, for example. Polyurethane resins may also be employed as well as other resins. Those skilled in the art will appreciate that the selection and amount of resin actually applied can depend on any of a variety of factors including, for example, fiber weight, fiber density, fiber type as well as the contemplated end use. Suitable synthetic fibers for production of such a web include those capable of withstanding the temperatures at which selected resins or adhesive binders are cured without deterioration.

In some lofty, non-woven web material embodiments, suitable fibers are between 20 and 110 mm, or between 40 and 65 mm, in length and have a fineness or linear density ranging from 1.5 to 500 denier, or from 1.5 to 100 denier. Fibers of mixed denier can also be used, as desired. In one embodiment, the non-woven substrate includes polyester or nylon fibers having linear densities within the range from 5 to 65 denier.

Lofty, non-woven web materials may be readily formed, e.g. air laid, for example, on a “Rando Webber” machine (commercially available from Rando Machine Company, New York) or may be formed by other conventional processes such as by carding or by continuous extrusion. Useful lofty, non-woven substrate materials have a fiber weight per unit area of at least 25 g/m², or at least 50 g/m², or between 50 and 1000 g/m², or between 75 and 500 g/m². Lesser amounts of fiber within the lofty, non-woven substrate materials will provide webs, which may be suitable in some applications.

The foregoing fiber weights will provide a useful non-woven substrate having a thickness from 5 to 200 mm, or between 6 to 75 mm, or between 10 and 30 mm. For phenolic prebond resins applied to a lofty, non-woven substrate having a fiber weight within the above ranges, the prebond resin is applied to the web or substrate in a relatively light coating, providing a dry add-on weight within the broad range from 50 to 500 g/m².

The foregoing lofty, non-woven substrate materials are effective for most scouring applications. For more intensive scouring applications, the lofty, non-woven substrate materials may be provided with abrasive particles dispersed and adhered there within. The abrasive particles can be adhered to the surfaces of the fibers in the lofty, non-woven substrate material. In many embodiments, the abrasive particles may include inorganic abrasive particles, organic based particles, sol gel particles or combinations thereof, all as known in the art. Examples of suitable abrasive particles as well as methods and binders for adhering abrasive particles onto the surfaces of the fibers are for example described in WO 97/49326.

In some embodiments, abrasive particles are adhered to the fibers of the non-woven substrate by a hardened organic resin binder such as, for example, a heat cured product of a thermosetting coatable resinous adhesive applied to the fibers of the non-woven substrate as a “binder precursor”. As used herein, “binder precursor” refers to a coatable resinous adhesive material applied to the fibers of the non-woven substrate to secure abrasive particles thereto. “Binder” refers to the layer of hardened resin over the fibers of the nonwoven web formed by hardening the binder precursor. In some embodiments, the organic resins suitable for use as a binder precursor in the non-woven substrate are formed from an organic binder precursor in a flowable state. During the manufacture of the non-woven substrate, the binder precursor can be converted to a hardened binder or make coat. In some embodiments, the binder is in a solid, non-flowable state. In some embodiments, the binder is formed from a thermoplastic material. In other embodiments, the binder is formed from a material that is capable of being cross-linked. In some embodiments, a mixture of a thermoplastic binder and a cross-linked binder is also useful.

During the process to make the web or substrate, the binder precursor can be mixed with the foregoing abrasive particles to form an adhesive/abrasive slurry that may be applied to the fibers of the non-woven by any of a variety of known methods such as roll coating, knife coating, spray coating, and the like. The thus applied binder precursor is then exposed to the appropriate conditions to solidify the binder. For cross-linkable binder precursors, the binder precursor can be exposed to the appropriate energy source to initiate polymerization or curing and to form the hardened binder.

In some embodiments, the organic binder precursor is an organic material that is capable of being cross-linked. The binder precursors can be either a condensation curable resin or an addition polymerizable resin, among others. The addition polymerizable resins can be ethylenically unsaturated monomers and/or oligomers. Examples of useable cross-linkable materials include phenolic resins, bis-maleimide binders, vinyl ether resins, aminoplast resins having pendant alpha,beta-unsaturated carbonyl groups, urethane resins, epoxy resins, acrylate resins, arylated isocyanurate resins, urea-formaldehyde resins, melamine formaldehyde resins, phenyl formaldehyde, styrene butadiene resins, isocyanurate resins, acrylated urethane resins, acrylated epoxy resins, or mixtures thereof. The binder precursor suitable for use is a coatable, hardenable adhesive binder and may comprise one or more thermoplastic or, thermosetting resinous adhesives. Resinous adhesives suitable for use in the present invention include phenolic resins, aminoplast resins having pendant alpha,beta-unsaturated carbonyl groups, urethane resins, epoxy resins, ethylenically unsaturated resins, acrylated isocyanurate resins, urea-formaldehyde resins, isocyanurate resins, acrylated urethane resins, acrylated epoxy resins, bismaleimide resins, fluorine-modified epoxy resins, and combinations thereof. Examples of these resins can be found in WO 97/49326. Catalysts and/or curing agents may be added to the binder precursor to initiate and/or accelerate the polymerization process. In many embodiments the substrate can withstand temperatures up to at least 200 degrees Celsius, (e.g., food preparation operating temperature.)

Commercially available non-woven substrate or web materials are available under the trade designation “Scotch-Brite™ General Purpose Scour Pad No. 96,” “Scotch-Brite™ Heavy Duty Griddle Cleaner No. 82 (non-woven glass cloth),” “Scotch-Brite™ All Purpose Scour Pad No. 9488R,” “Scotch-Brite™ Heavy Duty Scour Pad No. 86,” all available from 3M Co. In other embodiments, the substrate is a Scotch-Brite™ Griddle Screen No. 68, a Scotch-Brite™ Griddle Screen No. 200, steel-wool, pumice block, foamed glass bricks, and the like.

### EXAMPLES

All chemicals were used as commercially available.

Table of Abbreviations

| Abbreviation | Description |
|---|---|
| Quick Clean | Scotch-Brite ™ Quick Clean Griddle Liquid, No. 700, 3M Co., |
| | St. Paul, MN |
| FAME | Fatty Acid Mono Ester (Lauricidin ™), Med-Chem. |
| | Laboratories, Galena, IL |
| PEG | Poly(ethylene glycol) (1000 Da, 4600 Da, or 8000 Da), Aldrich, |
| | Milwaukee, WI. |
| Potassium Carbonate | Ashta Chemicals, Ashtabula, OH. |
| K₂CO₃ (anhydrous) | |
| Sodium Carbonate | J. T. Baker, Phillipsburg, NJ. |
| Na₂CO₃ (monohydrate) | |
| Stock Solution #1 | 10 g Potassium Carbonate/4 g Sodium Carbonate/20 g DI Water |
| Stock Solution #2 | 12 g Potassium Carbonate/6 g Sodium Carbonate/20 g DI Water |
| Stock Solution #3 | 10 g Potassium Carbonate/4 g Sodium Carbonate/15 g DI Water |
| Stock Solution #4 | 10 g Potassium Carbonate/4 g Sodium Carbonate/14 g DI Water |
| Glycerin | Merck KGaA, Darmstadt Germany |
| TONE Polyol 210 | Melting Point Range: 35° to 45° C., Dow/Union Carbide, |
| | Midland, MI |
| TONE Polyol 230 | Melting Point Range: 40° to 50° C., Dow/Union Carbide, |
| | Midland, MI |
| TONE Polyol 240 | Melting Point Range: 45° to 55° C., Dow/Union Carbide, |
| | Midland, MI |
| TONE Polyol 260 | Melting Point Range: 50° to 60° C., Dow/Union Carbide, |
| | Midland, MI |
| #46 Pad | Scotch-Brite ™ Griddle Polishing Pad No. 46, 3M Co., |
| | St. Paul, MN |
| #9488R Pad | Scotch-Brite ™ All Purpose Scouring Pad No. 9488R, 3M Co., |
| | St. Paul, MN |
| SPAN 40 | Sorbitan Monopalmitate Surfactant, Aldrich, Milwaukee, WI |
| SPAN 65 | Sorbitan Tristearate Surfactant, Imperial Chemical Industries |
| | (ICI), London, UK |
| Brij 35 | Dodecylpoly(ethylene glycol) ether surfactant, Uniquema (ICI), |
| | London, UK |
| Pluracare L44 NF | Block copolymer of poly(ethylene glycol) and poly(propylene |
| | glycol), BASF, Lundwigshafen, DE |
| BioSoft D-40 | Sodium Dodecylbenzene Sulphonate Surfactant, Stepan |
| | Company, Northfield, IL |
| EDTA | Ethylene Diamine Tetra Acetate - Sequesterant Eastman Kodak |
| | Co., Kingsport, TN |
| Xanthan Gum | R. T. Vanderbilt Company, Inc. Norwalk, CT. |
| Candelilla wax | Strahl & Pitsch, Inc., West Babylon, CT. |
| Sodium Metasilicate | J. T. Baker, Phillipsburg, NJ. |
| Sodium Bicarbonate | Mallinckrodt BaKER, Inc., Paris, KY |
| Melamine | Particle 40/100 mesh. Maxi-Blast, Inc., South Bend, IN. |
| formaldehyde particles | |
| Pumice 0 | Charles B. Chrystal Co., Inc. New York, NY |
| Pumice FF | Charles B. Chrystal Co., Inc. New York, NY |
| Emulsifying wax NF | Strahl & Pitsch, Inc., West Babylon, CT. |
| Cetyl Alcohol | TCI Mark |
| Stearyl Alcohol | Alfol 18 - Sasol North America Inc., Weslake, Louisiana. |

### Test Methods for Cleaning the Griddle

### Burnt Oil Test Method

1. Turn all three burners on the flat griddle (Star Mftg. Model 536-76A. Smithville Tenn.) to 450° F. (232° C.).
2. Measure about 40 mL of commercially available soybean oil (e.g., Crisco) and pour on the griddle.
3. Spread out oil with a 3M Green Scotch-Brite™ General Purpose Scour Pad No. 96 until even over entire surface of griddle.
4. Let griddle heat oil for 45 minutes. Oil should be dark brown and of fairly uniform color across the entire griddle.
5. Decrease the temperature of the griddle to 300-350° F. (150-175° C.).
6. Measure the temperature of the griddle with the IR thermometer (Dickson, Chicago, Ill.) and record it. It should be between 300-350° F. (150-175° C.).
7. Apply test cleaning composition on desired amount of griddle. 100 grams of test cleaning composition for the entire griddle.
8. Apply test cleaner over griddle surface with Scotch-Brite™ Griddle Polishing Pad No. 46 on pad holder and record the amount of time for the entire product to melt.
9. Turn off burner under section of griddle you are testing.
10. Immediately begin scrubbing using #46 pad and record amount of time necessary for acceptable level of cleanliness.
11. Scrape griddle surface with squeegee to move melted wax into grease trap.
12. Repeat cleaning over other surfaces of griddle with other test cleaners.
13. Using a wet paper towel on the pad holder, rinse surface and edges of griddle.
14. Apply a small amount of oil to surface of griddle and spread with Scotch-Brite™ General Purpose Scour Pad No. 96 to season the surface.
15. Wipe up any excess oil with a paper towel

### Ground Beef Test Method

1. Turn all three burners to 325° F. (160° C.).
2. Weigh 2.5 lbs (1.1 Kg) of ground beef for the entire griddle
3. Cook the beef until dark brown, moving the ground beef around the griddle to make it evenly distributed.
4. Remove the beef from the griddle with the flat cooking utensil taking off as much beef as possible.
5. Leave the food soil cooking for an extra 60 minutes
6. Measure the temperature of the griddle and record it. It should be between 300-350° F. (150-175° C.).
7. Apply test cleaner over desired amount of griddle. 100 g to 120 g of cleaning composition for the entire griddle.
8. Spread test cleaner over griddle surface with an appropriate pad (either 3M #46 Griddle Polishing Pad or 3M #9488R All Purpose Pad) on pad holder and record the amount of time for the entire product to melt.
9. Turn off burner under section of griddle you are testing.
10. Immediately begin scrubbing using the No. 46 pad and record amount of time necessary for acceptable level of cleanliness.
11. Scrape griddle surface with squeegee.
12. Repeat cleaning over the entire surfaces of griddle with other test cleaners.
13. Using a wet paper towel on the pad holder, rinse surface and edges of griddle.
14. Wash out drip tray of any remaining food soil.
15. Apply a small amount of oil to surface of griddle and spread with Scotch-Brite™ General Purpose Scour Pad No. 96 to season to surface.
16. Wipe up any excess oil with a paper towel.

Preparation of the Cleaning Compositions

Stock solutions were made by dissolving the salts indicated below in de-ionized water at low heat. The solution was stirred until no more solid salts were present.

The stock solutions and glycerin (Procter & Gamble, Cincinnati, Ohio) were added to a beaker and placed on a hot plate/stirrer. The solution was heated to about 80° C. while gently mixing. The solidifying agent (wax or polyol) was added to the stock solution/glycerin mix and heated while stirring until the solidifying agent was completely melted. The formulation was taken off the heat once it was well mixed and homogenous.

Tablets and impregnated pads were made by either pouring into the molds to form tablets or pads. Tablets were made by allowing the melted formulations to cool down to room temperature in an aluminum mold of 2″×2″×1″ (5 cm×5 cm×2.5 cm) (W×L×H). Tablets of 60 g each were made with this mold. Impregnated pads (#46) were also made by pouring the melted formulation on a mold of 4″×5″×1″ (10 cm×13 cm×2.5 cm) (W×L×H) at about 80° C., allowing it to cool down to about 60° C. and then placing the pad onto the mold and applying a little pressure to force the pad into the solidified cleaner. The pads were allowed to cool to room temperature.

Formulations were also made of the following waxes:
Rice bran wax (Koster Keunen, Inc., Watertown, Conn., USA)
Lemon peel Wax (Koster Keunen, Inc., Watertown, Conn., USA)
Soy wax flakes (Koster Keunen, Inc., Watertown, Conn., USA)
Deodorized orange peel wax (Koster Keunen, Inc., Watertown, Conn., USA)
Beeswax (Strahl & Pitsch, Inc., West Babylon, N.J., USA)
Candelilla wax (Strahl & Pitsch, Inc., West Babylon, N.J., USA)
Carnauba wax (Strahl & Pitsch, Inc., West Babylon, N.J., USA)

Formulation 1

A solid cleaner was made by combining 34 g of stock solution #1 with 22 g of glycerin and 44 g of beeswax.

Formulation 2

A solid cleaner was made by combining 34 g of stock solution #1 with 22 g of glycerin and 44 g of carnauba wax.

Formulation 3

A solid cleaner was made by combining 34 g of stock solution #1 with 22 g of glycerin and 44 g of candelilla wax.

Formulation 4

A solid cleaner was made by combining 34 g of stock solution #1 with 33 g of glycerin and 33 g of beeswax.

Formulation 5

A solid cleaner was made by combining 34 g of stock solution #1 with 33 g of glycerin and 33 g of carnauba wax.

Formulation 6

A solid cleaner was made by combining 34 g of stock solution #1 with 40 g of glycerin and 26 g of carnauba wax.

### Formulation 7

A solid cleaner was made by combining 34 g of stock solution #1 with 40 g of glycerin and 26 g of candelilla wax.

Formulation 8

A solid cleaner was made by combining 34 g of stock solution #2 with 40 g of glycerin and 26 g of candelilla wax.

Formulation 9

A solid cleaner was made by combining 34 g of stock solution #2 with 40 g of glycerin and 26 g of candelilla wax impregnated into a pad.

Formulation 10

A solid cleaner was made by combining 34 g of stock solution #2 with 40 g of glycerin and 26 g of beeswax impregnated into a pad.

Formulation 11

A solid cleaner was made by combining 34 g of stock solution #2 with 40 g of glycerin and 26 g of carnauba wax impregnated into a pad.

Formulation 12

A solid cleaner was made by combining 34 g of stock solution #2 with 40 g of glycerin and 26 g of lemon peel wax.

Formulation 13

A solid cleaner was made by combining 24 g of stock solution #2 with 40 g of glycerin and 26 g of carnauba wax and 10 g of sodium bicarbonate.

Formulation 14

A solid cleaner was made by combining 24 g of stock solution #2 with 40 g of glycerin and 26 g of carnauba wax and 10 g of sodium metasilicate.

Formulation 15

A solid cleaner was made by combining 34 g of stock solution #2 with 40 g of glycerin and 26 g of rice wax.

Formulation 16

A solid cleaner was made by combining 34 g of stock solution #2 with 40 g of glycerin and 26 g of orange peel wax.

### Results

Experimental samples were compared against Scotch-Brite™ Quick Clean Griddle Liquid No. 700 (Quick Clean or 700) (3M Company, St. Paul, Minn.) and rated for melting time (in seconds), and cleaning performance. A visual rating was given for cleaning performance. The rating scale went from 1 to 5, with 5 being no food residue left on the heated surface. The temperature of the griddle was recorded with an IR thermometer.

A comparison of the performance of the different experimental formulations against Quick Clean is shown in the table below.

Griddle Cleaner Evaluation

| | | | Griddle | Melting | |
|---|---|---|---|---|---|
| | | | Temperature | Time | Cleaning |
| Example | Formulation | Soil | (° F.) | (sec) | Performance |
| 1 | 1 | Oil | — | — | 3 |
| 2 | 2 | Oil | — | — | 3 |
| 3 | 3 | Oil | — | — | 3 |
| 4 | 4 | Oil | 330 (165° C.) | 38 | 3 |
| 5 | 5 | Oil | 325 (160° C.) | 45 | 3 |
| 6 | 6 | Oil | 300 (150° C.) | 42 | 3 |
| 7 | Quick Clean | Oil | 330 (165° C.) | N/A | 5 |
| 8 | 7 | Oil | 330 (165° C.) | 40 | 3 |
| 9 | 8 | Oil | 325 (160° C.) | 42 | 5 |
| 10 | 9 | Oil | 330 (165° C.) | — | 5 |
| 11 | 9 | Oil | 325 (160° C.) | 110 | 5 |
| 12 | 10 | Oil | 335 (168° C.) | 40 | 5 |
| 13 | 11 | Oil | 325 (160° C.) | 30 | 3 |
| 14 | 8 | Beef | 350 (175° C.) | 85 | 5 |
| 15 | 8 | Beef | 350 (175° C.) | 120 | 5 |
| 16 | 8 | Beef | 360 (182° C.) | 19 | 5 |
| 17 | 8 | Beef | 360 (182° C.) | 67 | 5 |
| 18 | Quick Clean | Beef | 340 (171° C.) | N/A | 5 |
| 19 | 11 | Oil | 350 (175° C.) | 45 | 5 |
| 20 | 12 | Oil | 340 (171° C.) | 54 | 5 |
| 21 | 15 | Oil | 330 (165° C.) | 38 | 5 |
| 22 | 16 | Oil | 325 (160° C.) | 32 | 3 |

### Further Prepared and Tested Samples:

The following formulations were made up using Quick Clean, FAME, PEG 1000, 4600 and 8000 as well as Stock Solutions #1 and #3 (defined in the Table of Abbreviations above).

Compositions in % wt

| | | PEG | | | Stock Solution | |
|---|---|---|---|---|---|---|
| Example # | FAME | 1000 | 4600 | 8000 | #1 | #3 |
| Quick Clean (1) | — | — | — | — | — | — |
| 23 | 16 | — | 50 | — | — | 34 |
| 24 | 16 | — | — | 50 | — | 34 |
| 25 | 36 | 30 | — | — | — | 34 |
| 26 | 36 | — | — | — | — | 34 |
| 27 | 36 | — | 30 | 60 | — | 34 |
| 28 | 50 | 16 | — | — | — | 34 |
| 29 | 50 | — | 16 | — | 34 | — |
| 30 | 50 | — | 16 | — | — | 34 |
| 31 | 50 | — | — | 16 | — | 34 |

The following formulations were made up using Glycerin, TONE Polyols (210, 230, 240 and 260), Stock Solution #3 (defined in the Table of Abbreviations above). In addition, Example #42 and #43 were loaded into a Scotch-Brite™ Griddle Polishing Pad No. 46.

Composition in % wt

| | | | | | | Stock | | |
|---|---|---|---|---|---|---|---|---|
| Example | | Difunctional TONE Polyol | | | | solution | | Loaded |
| # | Glycerin | 210 | 230 | 240 | 260 | #1 | #3 | Pad |
| 32 | 13 | 69 | — | — | — | — | 18 | NO |
| 33 | 13 | — | 69 | — | — | — | 18 | NO |
| 34 | 13 | — | — | 69 | — | — | 18 | NO |
| 35 | 13 | — | — | — | 69 | — | 18 | NO |
| 36 | 13 | 69 | — | — | — | — | 18 | YES |
| 37 | 13 | — | — | — | 69 | — | 18 | YES |

The following formulations were made up using Glycerin, TONE Polyols (210 and 260), SPAN 40, SPAN 65, Quick Clean and Stock Solutions #3 and #4 (defined in the Table of Abbreviations above).

Composition in % wt

| | | Difunctional TONE | | Surfactant | | | | |
|---|---|---|---|---|---|---|---|---|
| | | Polyol | | SPAN | SPAN | Quick | Stock Solution | |
| Example # | Glycerin | 210 | 260 | 40 | 65 | Clean | #3 | #4 |
| 38 | 13 | — | 61 | 10 | — | — | 16 | — |
| 39 | 13 | — | 61 | — | 10 | — | 16 | — |
| 40 | — | — | 77 | — | — | 23 | — | — |
| 41 | 13 | 41 | 33 | — | — | — | 13 | — |
| 42 | 13 | 67 | — | — | — | — | — | 20 |
| 43 | 13 | — | 68 | — | — | — | — | 19 |

The following formulations were made up using Glycerin, TONE Polyols (210 and 260), SPAN 40, Brij 35, Pluracare L44 NF, BioSoft D-40, PEG 1000, and Stock Solution #3 (defined in the Table of Abbreviations above).

Composition in % wt

| | | Difunctional | | Surfactants/Detergents | | | | | Stock |
|---|---|---|---|---|---|---|---|---|---|
| | | TONE Polyol | | Span | Brij | Pluracare | BioSoft | PEG | Sol. |
| Example # | Glycerin | 210 | 260 | 40 | 35 | L44 NF | D-40 | 1000 | #3 |
| 44 | 14 | 68 | — | — | 0.05 | — | — | — | 18 |
| 45 | 14 | 68 | — | — | — | — | 0.2 | — | 18 |
| 46 | 13 | 69 | — | — | — | 0.05 | — | — | 17 |
| 47 | 14 | 58 | — | — | — | — | — | 10 | 16 |
| 48 | 11 | — | 66 | — | — | — | — | 8 | 14 |
| 49 | 14 | 67 | — | 1 | — | — | — | — | 18 |
| 50 | 14 | — | 67 | 1 | — | — | — | — | 18 |

The following formulations were made up using Quick Clean, Glycerin, TONE Polyols (210 and 260), SPAN 40, EDTA, and Stock Solution #2 (defined in the Table of Abbreviations above).

Composition in % wt

| | | Difunctional | | | | Stock |
|---|---|---|---|---|---|---|
| Example | | TONE Polyol | | Surfactant | Sequester | Sol. |
| # | Glycerin | 210 | 260 | SPAN 40 | EDTA | #3 |
| 51 | 14 | — | 66 | — | 3 | 17 |
| 52 | 14 | 67 | — | 0.05 | 3 | 17 |
| 53 | 13 | 71 | — | 0.05 | 1 | 15 |

The following griddle cleaner formulations were made using Stock Solution #2, Glycerin, Candelilla Wax, and Xanthan Gum. The stock solution and glycerin were added to a beaker and placed on a hot plate/stirrer. The solution was heated to about 100° C. while gently mixing. The wax was added to the stock solution/glycerin mix and left in the heat while stirring until the wax was completely melted. Xanthan gum was added to the formulations at 100° C. after the wax was melted. The formulation was taken off the heat once it was well mixed and homogeneous.

Tablets and impregnated pads were made by either pouring into the molds to form tablets or pads. Tablets were made by allowing the melted formulation to cool down to room temperature in an aluminum mold of 2″×2″×1″ (5 cm×5 cm×2.5 cm) (W×L×H). Tablets of 50 g each were made with this mold. Impregnated pads (#46) were also made by pouring the melted formulation on a mold of 4″×5.5″×1″ (10 cm×14 cm×2.5 cm) (W×L×H) at about 80° C., allowing it to cool down to about 60° C. and then placing the pad and applying a little pressure. Pads of 100 g each were allowed to cool to room temperature.

| | Stock | | Candelilla | Xanthan |
|---|---|---|---|---|
| | Solution | Glycerin | Wax | Gum |
| Example # | #2 (g) | (g) | (g) | (g) |
| 54 | 42.7 | 41.0 | 16.3 | 0.0 |
| 55 | 42.2 | 40.4 | 16.1 | 1.2 |
| 56 | 40.2 | 38.5 | 15.4 | 5.9 |
| 57 | 39.3 | 37.6 | 15.0 | 8.1 |
| 58 | 50.0 | 29.4 | 19.1 | 1.5 |
| 59 | 47.2 | 27.8 | 18.1 | 6.9 |
| Formulation 9 | 34.0 | 40.0 | 26.0 | 0.0 |

Performance of these examples were compared to the control sample Formulation 9 (solid cleaner with no xanthan gum). Formulations were rated for cleaning performance. A visual rating was given for each of these qualitative attributes listed above. The rating scale went from 1 to 5, with 5 being best.

| | Stock | | | | | | |
|---|---|---|---|---|---|---|---|
| | Solution #2 | Glycerin | Candelilla | Xanthan | ratio | Melting time | Cleaning |
| Example # | (g) | (g) | Wax (g) | Gum (g) | Gly/Wax | (sec) | performance |
| 54 | 42.7 | 41.0 | 16.3 | 0.0 | 2.5 | 45 | 5 |
| 55 | 42.2 | 40.4 | 16.1 | 1.2 | 2.5 | 50 | 5 |
| 56 | 40.2 | 38.5 | 15.4 | 5.9 | 2.5 | 40 | 5 |
| 57 | 39.3 | 37.6 | 15.0 | 8.1 | 2.5 | 40 | 1 |
| 58 | 50.0 | 29.4 | 19.1 | 1.5 | 1.5 | 38 | 4 |
| 59 | 47.2 | 27.8 | 18.1 | 6.9 | 1.5 | 36 | 1 |
| Formulation | 34.0 | 40.0 | 26.0 | 0.0 | 1.5 | 45 | 5 |
| 9 | | | | | | | |

Results appear to indicate that formulations containing xanthan gum up to 6% were solid even when the amount of candelilla wax was significantly reduced from 26 g to 15-16 g. Examples 55 and 56 appear to show performance comparable to that of the control sample Formulation 9 (formulation with no thickener and higher wax content).

A variety of abrasive materials were added to Formulation 9 to form the Examples listed in the table below. The examples including abrasive materials were loaded onto the non-abrasive #9488R pad, while the Formulation 9 and the quick clean example was loaded onto an abrasive #46 pad. Tablets and impregnated pads were made by either pouring into the molds to form tablets or pads. Tablets were made by allowing the melted formulation to cool down to room temperature in an aluminum mold of 2″×2″×1″ (5 cm×5 cm×2.5 cm) (W×L×H). Tablets of 50 g each were made with this mold. Impregnated pads were also made by pouring the melted formulation on a mold of 4″×5.5″×1″ (10 cm×14 cm×2.5 cm) (W×L×H) at about 80° C., allowing it to cool down to about 60° C. and then placing the pad and applying a little pressure. Pads of 100 g each were allowed to cool to room temperature.

Performance of these examples were compared to the control sample Formulation 9 (solid cleaner with no abrasive) and to Quick Clean. Formulations were rated for cleaning performance. A visual rating was given for each of these qualitative attributes listed above. The rating scale went from 1 to 5, with 5 being best.

| | | Grams of | | Cleaning |
|---|---|---|---|---|
| | | Abrasive/ | | perfor- |
| Example # | Abrasive | 100 g of Wax | Soil | mance |
| 60 | Sodium Bicarbonate | 10 | Oil | 1 |
| 61 | Sodium Bicarbonate | 20 | Oil | 5 |
| 62 | Sodium Metasilicate | 10 | Oil | 1 |
| 63 | Sodium Metasilicate | 20 | Oil | 1 |
| 64 | Pumice 0 | 10 | Oil | 3 |
| 65 | Pumice 0 | 20 | Oil | 4 |
| 66 | Pumice 0 | 30 | Oil | 1 |
| 67 | Pumice 0 | 50 | Oil | 1 |
| 68 | Pumice FF | 10 | Oil | 3 |
| 69 | Pumice FF | 20 | Oil | 4 |
| 70 | Pumice 0 | 10 | Beef | 5 |
| 71 | Pumice FF | 10 | Beef | 5 |
| 72 | Melamine Resin | 10 | Oil | 5 |
| 73 | Melamine Resin | 20 | Oil | 5 |
| 74 | Melamine Resin | 30 | Oil | 5 |
| Formulation 9 | — | — | Oil | 5 |
| Quick Clean | — | — | Oil | 5 |
| Formulation 9 | — | — | Beef | 5 |
| Quick Clean | — | — | Beef | 5 |

These results appear to indicate that the performance of abrasive containing formulations was the same or better than the Quick Clean and control sample Formulation 9.

Emulsifying Wax NF was added to Formulation 9 to form the Examples listed in the table below. Tablets and impregnated pads were made by either pouring into the molds to form tablets or pads. Tablets were made by allowing the melted formulation to cool down to room temperature in an aluminum mold of 2″×2″×1″ (5 cm×5 cm×2.5 cm) (W×L×H). Tablets of 50 g each were made with this mold. Impregnated pads (#46) were also made by pouring the melted formulation on a mold of 4″×5.5″×1″ (10 cm×14 cm×2.5 cm) (W×L×H) at about 80° C., allowing it to cool down to about 60° C. and then placing the pad and applying a little pressure. Pads of 100 g each were allowed to cool to room temperature.

Performance of these examples were compared to the control sample Formulation 9 (solid cleaner with no emulsifying wax). Formulations were rated for cleaning performance. A visual rating was given for each of these qualitative attributes listed above. The rating scale went from 1 to 5, with 5 being best.

| | Stock | | | | | | |
|---|---|---|---|---|---|---|---|
| | Solution #2 | Glycerin | Candelilla | Emulsifying | ratio | Melting | Cleaning |
| Example # | (g) | (g) | Wax (g) | Wax NF (g) | Cand/Emul | time (sec) | performance |
| 75 | 34 | 40 | 13 | 13 | 1:1 | 25 | 5 |
| 76 | 34 | 40 | 9 | 17 | 1:2 | 30 | 5 |
| 77 | 34 | 40 | 17 | 9 | 2:1 | 30 | 5 |
| 78 | 34 | 40 | 20 | 6 | 3:1 | 35 | 5 |
| Formulation | 34 | 40 | 26 | 0 | 0 | 45 | 5 |
| 9 | | | | | | | |
| 79 | 34 | 30 | 13 | 13 | 1:1 | 30 | 5 |
| 80 | 34 | 25 | 13 | 13 | 1:1 | 25 | 5 |
| 81 | 34 | 20 | 13 | 13 | 1:1 | 25 | 5 |

These results appear to indicate that formulations that contain Emulsifying Wax NF melt faster than the control sample formulation 9. In addition, formulations that contain Emulsifying Wax NF were reported to have less “drag” when applied to the heated surface than the control sample formulation 9.

The following formulations were made up using stock solution #2, glycerin, wax and an emulsifying wax (cetyl and/or stearyl alcohol).

| | Stock | | | | | | | |
|---|---|---|---|---|---|---|---|---|
| | Solution #2 | Glycerin | Candelilla | Carnauba | Cetyl | Stearyl | Melting | Cleaning |
| Example # | (g) | (g) | Wax (g) | Wax (g) | Alcohol (g) | Alcohol (g) | time (sec) | performance |
| 82 | 34 | 40 | 13 | 0 | 0 | 13 | 38 | 5 |
| 83 | 34 | 40 | 13 | 0 | 13 | 0 | 35 | 5 |
| 84 | 34 | 40 | 13 | 0 | 6.5 | 6.5 | 38 | 5 |
| 85 | 34 | 40 | 0 | 13 | 0 | 13 | 48 | 5 |
| 86 | 34 | 30 | 0 | 13 | 0 | 13 | 33 | 5 |

All references and publications cited herein are expressly incorporated herein by reference in their entirety into this disclosure. Illustrative embodiments of this disclosure are discussed and reference has been made to possible variations within the scope of this disclosure. These and other variations and modifications in the disclosure will be apparent to those skilled in the art without departing from the scope of this disclosure, and it should be understood that this disclosure is not limited to the illustrative embodiments set forth herein. Accordingly, the disclosure is to be limited only by the claims provided below.

Referring to FIGS. 3a-c and 4a-c, alternative embodiments of the pad 20 shown in FIGS. 1 and 2 are shown. The pad 40 includes a stepped cross sectional profile that is different than the cross sectional profile of pad 20. The pad 40 includes valleys 42 separated by peaks 44, however, the pad 40 includes angled edge surfaces 46 and 48 that slope away from the flat surface 50 of the peaks 44 down towards the flat surface 52 of the valleys 42. Pad 40 may be preferred over the stepped profile of pad 20 for some griddle surface configurations. For example, in contrast to the griddle 34 shown in FIG. 1, which has straight vertical edge surfaces 54 and 56 (shown in FIG. 1), as shown in FIG. 3b other griddle configurations include sloped surfaces 60 and 62 that connect the high portions 64 of the griddle surface to the low portions 66 of the griddle surface. In addition, other griddle configurations may include curved top surfaces 70 and curved bottom surfaces 72 that are connected by curved side surfaces 74 and 76. For such griddle configurations, the pad 40 may be preferred.

Still referring to FIGS. 3a-c and 4a-c, the stepped profile of pad 40 may also be preferred in situations where the pad 40 is expected to be used on griddle surfaces having unknown or variable grooved spacing GGS. The flat surface 50 of the pad 40 can be configured such that it will fit between grooves even on griddles having grooves that are relatively close together. In one embodiment the width W1 of the flat surface 50 is set to fit in the grooves of griddles having the smallest griddle spacing GGS, and the distance D2 from the center of one valley to the next is set to accommodate the raised portion of griddles having the largest griddle spacing GGS. In such embodiments the distance between the center of two adjacent valleys D2 may be greater than twice the width W1 of the flat surface 50.

The pad 40 in the depicted embodiment is geometrically configured such that a single model can work well to clean a number of different commercially available griddles having different surface configurations. While in use the pad 40 can be moved back and forth along the griddle grooves in the X-direction while biased against the right side 78 of the peaks 80 in the positive Y-direction (shown in FIG. 4b) to clean the first portion 82 of the griddle surface. Next, the pad 40 can be moved back and forth along the grooves in the X-direction while biased against the left side 84 of the peaks 80 in the negative Y-direction (shown in FIG. 4c) to clean the second portion 86 of the griddle surface.

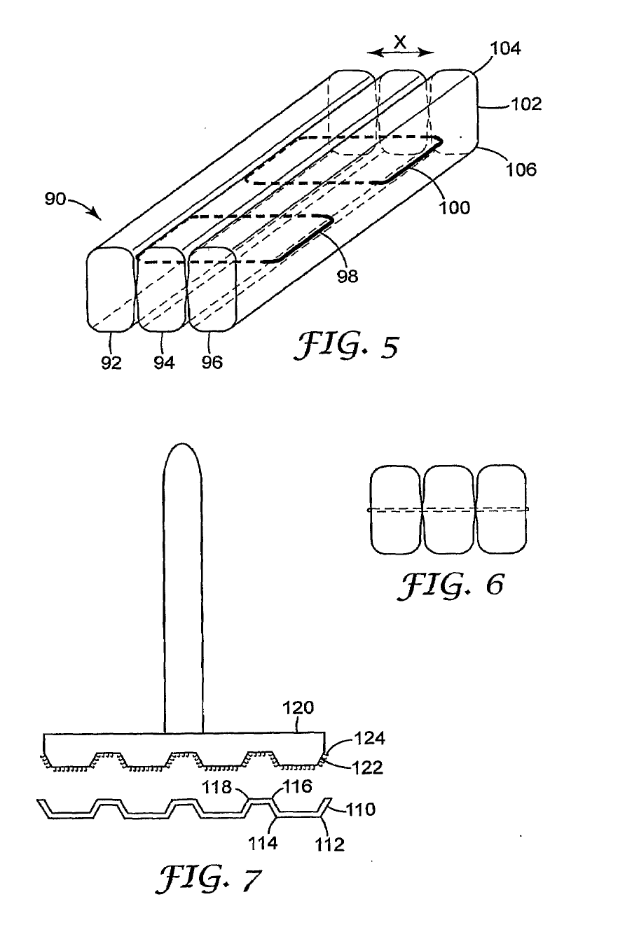

Referring to FIGS. 5 and 6, another embodiment of the pad according to the invention is shown. The pad 90 includes a plurality of separate pad sections 92, 94, and 96 that are held together by metal wire loops 98 and 100. The metal wires loops 98 and 100 extend through a center portion 102 of each of the separate pad sections 92, 94, and 96, thereby holding the center portions 102 of each pad section 92, 94 and 96 together. The upper end portions 104 and lower end portions 106 of each pad section 92, 94, and 96 are free to deflect a small distance in the X-direction relative to each other. The capability of the cleaning end 106 or 104 to deflect can enable the pad 90 to be more compatible with griddles having different groove spacing GGS and different surface profiles. As pressure is applied to the pad 90 the pad deforms such that the pad 90 matches the surface profile of whatever griddle surface configuration it is position over. It should be appreciated that many other suitable materials may be used in place of metal loop 98 and 100 to hold the pad sections 92, 94, and 96 together. For example, in an alternative embodiment nylon straps may be used in place of the metal wires 98 and 100. It should also be appreciated that any number of strap configurations can be used to band the pad together. In other words, the device that holds the pads 92, 94, and 96 together need not be looped. For example, in other embodiments the pads 92, 94, and 96 may be stapled together, heat staked together, ultrasonically bonded, or glued together. In should also be appreciated that though only three pad sections 92, 94, and 96 are shown, any number of pad sections may be used to form the complete pad 90.

Referring to FIG. 7, another embodiment of the pad according to the invention is shown. The pad 110 includes preformed creases 112, 114 116 and 118 that enable the pad 110 to better fit the step profile bottom surface of the shoe 120. The bottom of the shoe 120 can include any type of step profile desired. In the depicted embodiment the bottom surface 122 of the shoe 120 includes a plurality of hooks 124 that engage and secure the pad 110 thereto. It should be appreciated that though in the depicted embodiment the bottom surface 122 includes hooks 124 all across the bottom surface 122, in alternative embodiments means other than hooks 124 may be used in attaching the pad 110 to the shoe 120 or possibly only particular areas of the bottom surface 122 may include hooks 124. The creases 112, 114, 116 and 118 can be imparted onto the pad 110 by melting the pad along the creases to create a natural fold line in the pad 110. Other means of creating the creases include scoring the pads along the fold lines.

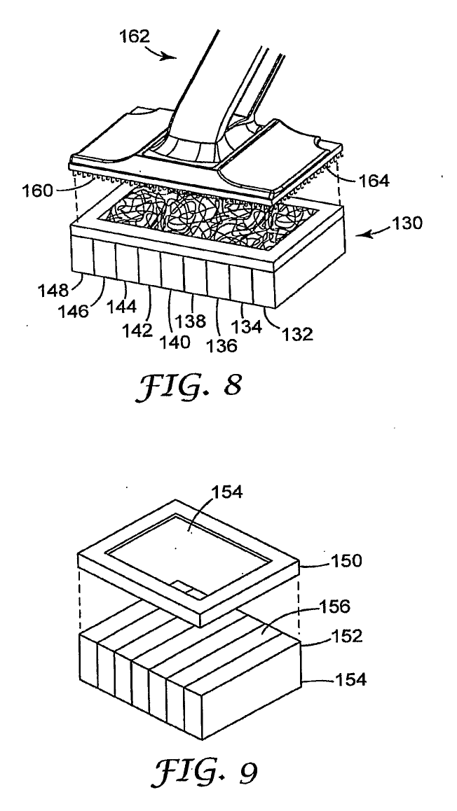

Referring to FIGS. 8 and 9, another embodiment of the pad is shown. The pad 130 includes a number of pad members 132-148 that are stacked adjacent to each other and held together by a binding member 150. The binding member 150 engages and secures the upper portions 152 of each pad 132-148 together to create a cleaning block. Relative to the upper portions 152, the lower portions 154 of the pad members 132-148 are free to deflect. This deflection provides advantages in that the pad 130 can be used to clean a large variety of griddles having different surface geometries. When the pad 130 is pressed onto the griddle surface it conforms to fit the particular surface configuration of the griddle. In the embodiment shown each pad has a generally rectangular shape, but the block can be of any other shape as well. The upper portions 152 can be held together solely by the binding member 150, or they can be glued or mechanically fastened together. For example, the metal wires 98 and 100 of the embodiment shown in FIGS. 5 and 6 can be used to hold the top portions 152 of the pads 132-148 together.

Referring to FIGS. 8 and 9, a method of assembling the pad 130 is shown. The method includes arranging pad members 132-148 adjacent each other and connecting the top portions of the pad members 132-148 together, then fitting the binding member 150 over the top portions 152 and around the pad members 132-148. The binding member 150 includes an opening 154 that exposes portions of the upper edges 156. The exposed portions of the upper edges engage the hooks 160 that extend from the foot portion 164 of the cleaning tool 162. In the depicted embodiment the binding member 150 is a molded plastic part that is shaped like an open box frame with the center of the bottom of the box removed. In an alternative embodiment the binding member 150 could be constructed of a different material such as cardboard. In addition, many other ways to attach the pad 130 to the handle 162 are possible.

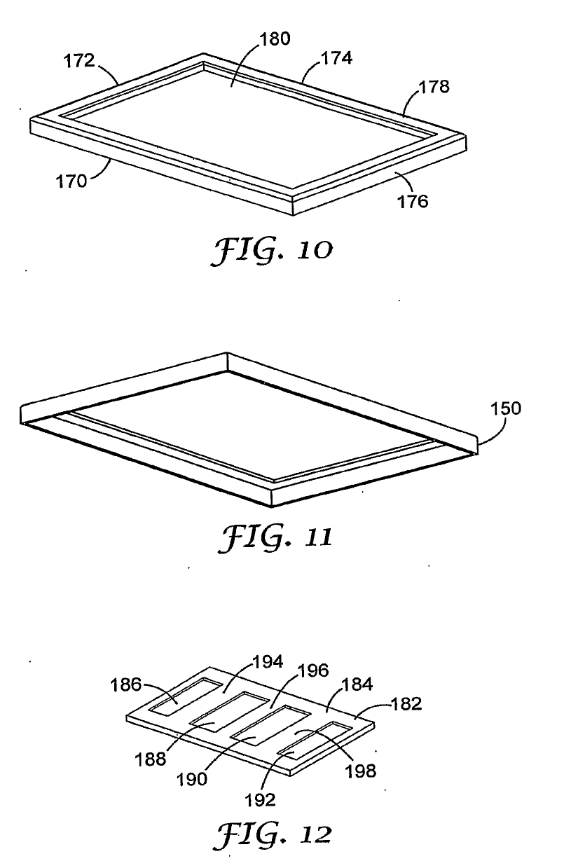

Referring to FIGS. 10 and 11 the binding member 150 is shown in greater detail. The binding member includes four side surfaces 170, 172, 174, 176 and top surface 178. The top surface includes at least one opening 180 to allow the handles to engage the pad members (see FIG. 9). An alternative embodiment of the binding member 150 is shown in FIG. 12. The binding member 182 includes a top surface 184 that has four openings 186, 188, 190, and 192 instead of a single opening. In this embodiment the handle engages the pad members (see FIG. 9) through the four openings 186, 188, 190, and 192. The web portions 194, 196 and 198 provide additional support for the pad members (see FIG. 9).

The above specification provides a complete description of the manufacture and use of the composition of the invention. It should be understood that features from the depicted embodiments can be combined to form new embodiments not specifically depicted. Moreover, since many embodiments of the invention can be made without departing from the spirit and scope of the invention, the invention resides in the claims hereinafter appended.

1. A griddle cleaning pad comprising:
a scrubbing pad comprising a working front surface and opposite back surface, the working front surface including a plurality of longitudinal spaced apart openings extending parallel across the front surface, wherein at least one of the openings is configured to receive a raised griddle member.

2. The pad according to claim 1, wherein each scrubbing pad comprises a non-woven material constructed to clean a griddle surface.

3. The pad according to claim 1, wherein the openings are disposed between free ends of a plurality of scrubbing members, the free end of each scrubbing member being opposed to fixed ends of the scrubbing member that are secured by a binding member.

4. The pad according to claim 3, wherein the binding member is a box shaped frame including four sides and a top and is configured to house a portion of the fixed ends of each of the scrubbing members.

5. The pad according to claim 4, wherein the top portion of the binding member is configured to removably engage a griddle cleaning tool.

6. The pad according to claim 4, wherein the top portion of the binding member includes an opening to enable hooks from the griddle cleaning tool to engage the fixed ends of the scrubbing members.

7. The pad according to claim 1, wherein the openings comprise channels cut into a flat cleaning surface of a scrubbing pad, wherein each channel is configured to match the surface profile of the raised griddle member.

8. The pad according to claim 7, wherein the distance between the channels is within 20 percent of the distance between the raised griddle members of a grooved griddle that the cleaning pad is designed to clean.

9. The pad according to claim 1, wherein the scrubbing pad includes a stepped cleaning surface including a plurality of peaks separated by a plurality of valleys, the peaks include a flat surface configured to engage low portions of a griddle disposed between pairs of raised griddle members.

10. The pad according to claim 9, wherein the width of the flat surface of the peaks is less than half of the distance between the center of adjacent valleys.

11. A method of cleaning a hot griddle comprising the steps of:
removably attaching a scrubbing pad to a handle member of a cleaning tool, wherein the scrubbing pad includes openings spaced apart and configured to engage raised griddle members;
pressing the scrubbing element against the griddle surface such that the raised griddle members are received within the openings in the scrubbing pad;
moving the scrubbing element forward and backwards along the griddle in a direction generally parallel to the raised griddle members until the griddle surface is clean.

12. The method according to claim 11, wherein the step of attaching a scrubbing pad to a handle includes engaging hooks disposed on a bottom surface of the handle with the scrubbing pad.

13. The method according to claim 11, further comprising biasing the scrubbing pad against a first side of the raised griddle member while moving the scrubbing element forward and backwards to clean the first side surface of a raised griddle member and biasing the scrubbing element against a second side of the raised griddle member while moving the scrubbing element forward and backwards to clean a second side surface of the raised griddle member.

14. The method according to claim 11, wherein the scrubbing pad includes a non-woven material constructed to clean a griddle surface.

15. A method of constructing a griddle cleaning pad comprising:
arranging a plurality of scrubbing pad elements adjacent one another to form a rectangular block of scrubbing pad elements; and
fitting a binding member over a first end of the block such that the first end of the scrubbing pad elements are held within the binder member.

16. The method of claim 15, wherein the scrubbing pad element comprises a non-woven material constructed to clean a griddle.

17. The method of claim 15, further comprising the step of providing an aperture within the binder member that is configured to enable a handle to engage the scrubbing pad elements.

18. The method of claim 15, further comprising molding a polymeric material to form a binder member.

19. A method of constructing a griddle cleaning pad comprising:
cutting a plurality of evenly spaced channels into a non-woven cleaning element, each channel being configured to engage a raised griddle member of a grooved griddle.
